(19) United States
(12) Patent Application Publication
(10) Pub. No.: US 2014/0253707 A1
(43) Pub. Date: Sep. 11, 2014

(54) AUTOMATED ACQUISITION OF EYEGLASSES

(71) Applicant: Dasa V. Gangadhar, Wichita, KS (US)

(72) Inventor: Dasa V. Gangadhar, Wichita, KS (US)

(21) Appl. No.: 13/793,127

(22) Filed: Mar. 11, 2013

(51) Int. Cl. G06K 9/00

(52) U.S. Cl. CPC G06K 9/00275
USPC 348/77; 382/100

(57) ABSTRACT

A computer program, a method, and a system for automated acquisition of eyeglasses. The computer program, method, and system include a kiosk and/or an electronic resource that obtain an image of a user; calculate facial measurements of the user based on the image; present images of eyeglass frames that correspond to the calculated facial measurements; obtain eyeglass prescriptions from a prescription provider; and order eyeglasses that corresponds the calculated facial measurements and that include lenses that correspond to the obtained eyeglass prescriptions.

### FIELD

Embodiments of the present invention are directed to a computer program, a method, and a system for automated acquisition of eyeglasses. In more detail, embodiments of the present invention are directed to a computer program, a method, and a system for acquiring eyeglasses for a user, with the eyeglasses including custom fit frames and prescription lenses.

### BACKGROUND

Presently, customers can shop for and purchase prescription and non-prescription eyewear from various types of brick-and-mortar retailers, such as department stores, specialty retail stores, or eye-care professional optical shops. Each type of retailer offers certain benefits and drawbacks for customers. For instance, shopping for eyewear at department stores may be convenient because of the large number of department store locations from which the customer can choose. Additionally, department stores generally offer relaxed atmospheres in which to shop and make purchases. However, eyewear offered by department stores is generally not fitted specifically for the customer. Thus, the customer is generally restricted to purchasing whatever eyewear is presently in-stock and available. Alternatively, specialty retail stores and eye-care professional optical shops may offer eyewear that is custom fit for the customer and the customer's intended use. However, such stores and shops may not be as convenient for the customer because there are fewer locations to choose from, and the customers are required to shop in a less-relaxed atmosphere. Additionally, customers may be required to make appointments to shop for eyewear in eye-care professional optical shops.

In addition to brick-and-mortar retail stores, there are numerous online retailers that allow customers to shop for and purchase eyewear online. The online retailers include similar advantages and drawback as department store retailers. For instance, the online retailers generally provide simple and convenient access, as well as a relaxed shopping environment. However, it is difficult for a customer to obtain eyewear that is custom fit for the customer's size requirements and the customer's intended use. Further, customers that purchase eyewear from online retailers cannot sample or try-on the eyewear until after they have purchased and received the eyewear. Thus, customers will generally be required to spend significant amounts of money on eyewear that they are not sure fits or otherwise conforms to their intended use.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

Embodiments of the present invention include a system and a method for automated acquisition of eyeglasses. The system may include a kiosk, with an imaging device and a computer. In embodiments of the present invention, the computer may further include a computer-readable storage medium with an executable program for instructing a process to perform the steps of the method. The method may include the initial step of obtaining an image of a user, with the image of the user including facial characteristics of the user. In the next step, embodiments of the present invention calculate facial measurements based on the image of the user. One or more images of eyeglass frames are then presented to the user, with the eyeglass frames in the one or more presented images of eyeglass frames corresponding to the calculated facial measurements of the user. In the next step, a selection of an eyeglass frame to order is obtained from the user, with the eyeglass frame to order having been included in the one or more presented images of eyeglass frames. In the next step, embodiments of the present invention connect to a prescription provider and obtain an eyeglass prescription of the user. In the next step, embodiments of the present invention connect to an eyeglass provider and place an order for eyeglasses, with the ordered eyeglasses including the eyeglass frame to order and lenses corresponding to the obtained eyeglass prescription of the user.

Embodiments of the present invention also provide for an additional method for automated acquisition of eyeglasses. The method includes the initial step of providing a kiosk for receiving a first set of eyeglass ordering information from a first user of said kiosk. In the next step, the method includes providing an electronic resource for receiving a second set of eyeglass ordering information from a second user of a computing device other than the kiosk. Finally, the method includes the step of filling orders for customized eyeglasses for said first and second users based on said first and second eyeglass ordering information, respectively.

### BRIEF DESCRIPTION OF THE DRAWING FIGURES

Embodiments of the present invention are described in detail below with reference to the attached drawing figures, wherein:

FIG. 1 is a flow chart of a method for automatically acquiring eyeglasses according to embodiments of the present invention;

FIG. 2 is a schematic depiction of an eyeglass acquisition system for automatically acquiring eyeglasses in accordance with embodiments of the present invention;

FIG. 3 is a perspective view of a kiosk for automatically acquiring eyeglasses, with the kiosk including an enclosure, an image sensor, a graphic display, and a mock eyeglasses dispenser;

FIG. 4 is a perspective view of mock eyeglasses that can be dispensed from the mock eyeglasses dispenser of the kiosk from FIG. 3;

FIG. 5 is a perspective view of an illustrative image of a front of a user's head obtained with the image sensor of the kiosk from FIG. 3;

FIG. 6 is a perspective view of an illustrative image of a side of a user's head obtained with the image sensor of the kiosk from FIG. 3;

FIG. 7 is a perspective view of a user providing an image of the user's head to a computing device, with the user wearing the mock eyeglasses from FIG. 4;

FIG. 8 is a perspective view of an illustrative image of a front of a user's head obtained with the computing device shown from FIG. 7, with the user wearing the mock eyeglasses from FIG. 4;

FIG. 9 is a perspective view of an illustrative image of a side of a user's head obtained with the computing device shown from FIG. 7, with the user wearing the mock eyeglasses from FIG. 4; and

FIG. 10 is a flow chart of an additional method for automatically acquiring eyeglasses according to embodiments of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

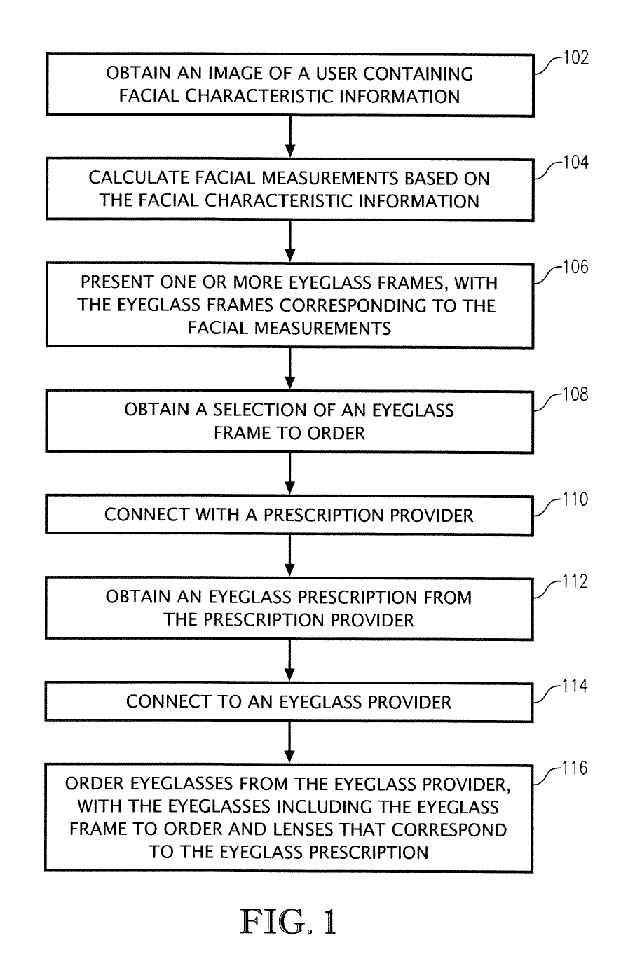

The present invention provides various embodiments of a computer program, a method, and a system for an automated acquisition of eyeglasses. As illustrated in FIG. 1, embodiments of the present invention may include a method with an initial Step 102 of obtaining an image of a user. The image of the user may include at least portions of the user's head and face area, such that the image includes facial characteristic information of the user. In Step 104, facial measurements of the user are calculated based on the facial characteristic information included in the image of the user. In the next Step 106, the user is presented with one or more images of eyeglass frames, with the eyeglass frames presented in the images corresponding to the facial measurements of the user. After the one or more images of eyeglass frames are presented, embodiments of the present invention obtain a selection for an eyeglass frame to order in Step 108. The eyeglass frame to order will generally have been included in the one or more eyeglass frame images presented to the user. In Step 110, embodiments of the present invention connect with a prescription provider, and in Step 112, an eyeglass prescription of the user is obtained from the prescription provider. In Step 114, embodiments of the present invention connect to an eyeglass provider, and in Step 116, eyeglasses are ordered from the eyeglass provider. The ordered eyeglasses will include the eyeglass frames to order, which includes eyeglass frames that correspond to the calculated facial measurements, and will further include lenses that correspond to the obtained eyeglass prescription of the user.

The computer program of embodiments of the present invention comprises a plurality of code segments executable by a computing device for performing the steps of the method of the present invention. The steps of the method may be performed in the order shown in FIG. 1, or they may be performed in a different order. Furthermore, some steps may be performed concurrently as opposed to sequentially. Also, some steps may be optional.

### System Description

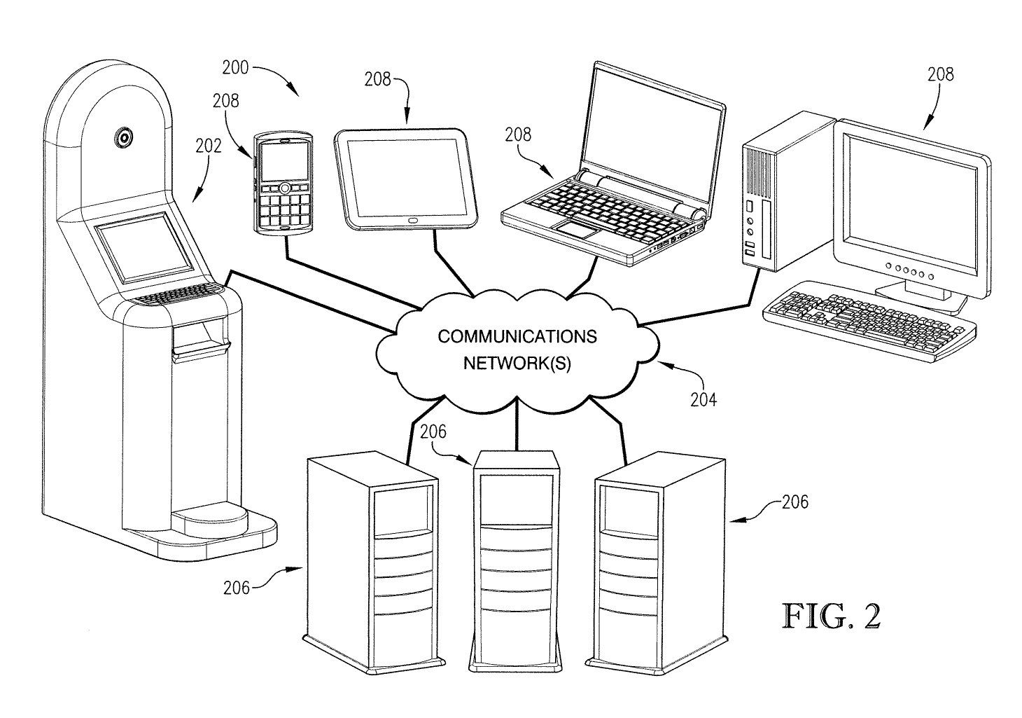

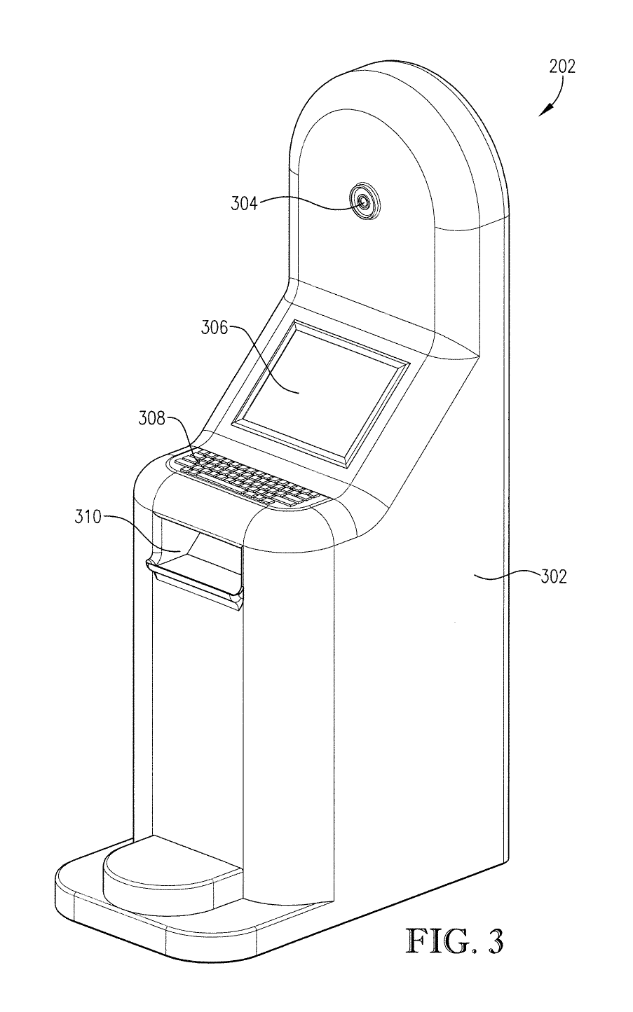

The computer program, system, and method of embodiments of the present invention may be implemented in hardware, software, firmware, or combinations thereof using the eyeglass acquisition system 200, shown in FIG. 2, which broadly comprises a kiosk 202, a communications network 204, server devices 206, and may further include computing devices 208. As illustrated in FIG. 3, the kiosk 202 broadly comprises an enclosure 302 that includes therewith a kiosk computer (not shown), an image sensor 304, a graphic display 306, a user interface 308, and a dispenser 310 for mock eyeglasses. The enclosure 302 may be of any size or shape as may be required to function according to embodiments of the present invention. In certain embodiments, the enclosure 302 may be sized similar to the enclosure illustrated in FIG. 3, such that the enclosure is approximately six feet tall, by approximately two feet wide, by approximately three feet deep. The enclosure 302 illustrated in FIG. 3 may be used in embodiments where the kiosk 202 is intended for use by a user that is standing in an upright position. However, the size of the enclosure may be smaller or larger for other embodiments. Further, the kiosk 202 may include a seating device, such that a user can implement the kiosk while in sitting position.

The kiosk computer of the kiosk 202 may include any device, component, or equipment with processing elements and associated memory elements necessary to perform the functions and features of the kiosk. The processing element may implement operating systems, and may be capable of executing the computer program, or portions of the computer program, which is also generally known as instructions, commands, software code, executables, applications (“apps”). The processing element may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. The kiosk may additionally include the necessary wired or wireless connection components for communicating with other components of the kiosk 202, which are each discussed in more detail below. In additional embodiments, the kiosk 202 may not include memory elements, but may include components capable of executing the computer program stored on a memory element(s) of the server 206 (e.g., such as in a cloud computing environment).

The image sensor 304 of the kiosk 202 may comprise various types of optical devices such as digital cameras, video camera, optical scanners, or the like, such that the image sensor is capable of capturing, transmitting, and/or storing digital images and/or videos of users. The image sensor 304 may transmit images of users to the kiosk computer for storage or for performing data manipulation, which will be discussed in more detail below. In certain embodiments, such as illustrated in FIG. 3, the kiosk 202 may only include one image sensor 304. However, additional embodiments may provide for the kiosk 202 to include more than one image sensor 304. For example, the kiosk 202 may include one, two, three, or any other number of image sensors 304, such that the image sensors can obtain multiple images of various aspects and angles of a user.

The graphic display 306 of the kiosk 202 may include any type of electronic display, such as a cathode ray tube, liquid crystal display, plasma, or touch screen that is operable to display visual graphics, images, videos, text, or the like. In certain embodiments, the graphic display 306 may be electronically connected to the kiosk computer. For instance, the computer program of the present invention may be stored on the kiosk computer and may facilitate interaction and communication through a graphical user interface (GUI) that is displayed via the graphic display 306.

The user interface 308 of the kiosk 202 enables one or more users to share information and commands, via a connection, with the kiosk, including the kiosk computer. The user interface 308 may facilitate interaction through the GUI described above or may additionally comprise one or more functionable inputs such as buttons, keyboard, switches, scrolls wheels, voice recognition elements such as a microphone, pointing devices such as mice, touchpads, tracking balls, styluses. The user interface 308 may also include a speaker for providing audible instructions and feedback. Further, the user interface 308 may comprise wired or wireless data transfer elements, such as a communication component, removable memory, data transceivers, and/or transmitters, to enable the user and/or other computing devices to remotely interface with the kiosk.

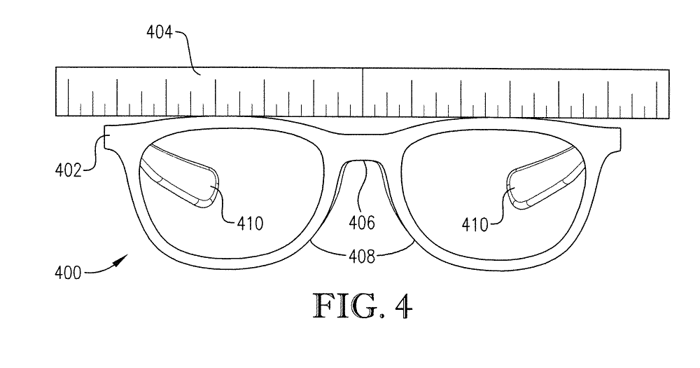

The kiosk 202 may further include the mock eyeglasses dispenser 310, with the mock eyeglasses dispenser being operable to dispense a set of mock eyeglasses 400, as illustrated in FIG. 4, to a user. The mock eyeglasses 400 may include a mock eyeglass frame 402 with a measuring device 404 attached to the mock eyeglass frame. The mock eyeglass frame 402 may include the basic components associated with eyeglasses, such as a bridge piece 406, lens rims 408, and temple stems 410, and may be made from plastic, cardboard, or other material. In addition, however, the mock eyeglass frame 402 may not include all of the basic components, but may include only those components necessary to secure the mock eyeglasses 400 to a user's head. For instance, the mock eyeglass frame 402 may simply include temples stems attached to ends of the measuring device 404. The measuring device 404 of the mock eyeglasses 400 may be any type of measuring device with markings of known distance, such as a ruler or pre-manufactured scaling device. The kiosk 202 may include the necessary mechanical components necessary to store the mock eyeglasses 400 within the kiosk and to dispense the mock eyeglasses to a user through the mock eyeglasses dispenser 310. In certain embodiments the mock eyeglasses 400 may be continuously dispensed from the mock eyeglasses dispenser 310. However, in other embodiments, the mock eyeglasses 400 may only be dispensed when instructed to by the computer program of embodiments of the present invention, such as when a user request to obtain the mock eyeglasses from the kiosk 202.

The enclosure 302 of the kiosk 202 may enclose portions of the components of the kiosk. For instance, the enclosure 302 may completely enclose the kiosk computer. However the enclosure 302 may only enclose certain portions of the other components of the kiosk, such as the image sensor 304, the graphic display 306, and the user interface 308, such that exposed portions of the components are available for interaction with users. For example, the enclosure 302 may have an opening near a lens of the image sensor 304, such that a lens is free to obtain an image of a user who is positioned in front of the kiosk 202. In other embodiments, the enclosure 302 may not enclose all of the other components of the kiosk 202, such the other components may reside independently of the kiosk. However, in such an embodiment, the other components may maintain communication with the kiosk 202, via the communications network 204.

The communications network 204 may be wired or wireless and may include servers, routers, switches, wireless receivers and transmitters, and the like, as well as electrically conductive cables or optical cables. The communications network 204 may also include local, metro, or wide area networks, as well as the Internet, or other cloud networks. Furthermore, the communications network 204 may include cellular or mobile phone networks, as well as landline phone networks, public switched telephone networks, fiber optic networks, or the like.

The server devices 206 may include devices that provide access to one or more general computing resources, such as Internet services, electronic mail services, data transfer services, and the like. The server devices 206 may also provide access to an eyeglass database that stores eyeglass information necessary for the implementation of the computer program, system, and method of embodiments of the present invention.

The server devices 206 and computing devices 208 may include any device, component, or equipment with processing elements and associated memory elements. The processing elements may implement operating systems, and may be capable of executing the computer program, which is also generally known as instructions, commands, software code, executables, applications (“apps”), and the like. The processing elements may include processors, microprocessors, microcontrollers, field programmable gate arrays, and the like, or combinations thereof. The memory elements may be capable of storing or retaining the computer program and may also store data, typically binary data, including text, databases, graphics, audio, video, combinations thereof, and the like. The memory elements may also be known as a “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, the server devices 206 may further include file stores comprising a plurality of hard disk drives, network attached storage, or a separate storage network.

The computing devices 208 may specifically include mobile communication devices (including wireless devices), work stations, desktop computers, laptop computers, palmtop computers, tablet computers, portable digital assistants (PDA), smart phones, and the like, or combinations thereof. Various embodiments of the computing device 208 may also include voice communication devices, such as cell phones or landline phones. In preferred embodiments, the computing device 208 will additionally comprise a camera such as a digital camera, video camera, or the like, such that the computing device can capture, store, and transmit digital images and/or videos. In additional preferred embodiments, the computing device 208 may include an electronic display, such as a cathode ray tube, liquid crystal display, plasma, or touch screen that is operable to display visual graphics, images, text, etc. In certain embodiments, the computer program of the present invention facilitates interaction and communication through a GUI that is displayed via the electronic display.

The computing devices 208 may include a user control interface that enables one or more users to share information and commands with the computing devices or server devices 206. The user control interface may facilitate interaction through the GUI described above or may additionally comprise one or more functionable inputs such as buttons, keyboard, switches, scrolls wheels, voice recognition elements such as a microphone, pointing devices such as mice, touchpads, tracking balls, styluses. The user control interface may also include a speaker for providing audible instructions and feedback. Further, the user control interface may comprise wired or wireless data transfer elements, such as a communication component, removable memory, data transceivers, and/or transmitters, to enable the user and/or other computing devices to remotely interface with the computing device 208.

The kiosk 202, the server devices 206 and the computing devices 208 may be connected to the communications network 204. The kiosk 202 may communicate with other kiosks, server devices 206, or computing devices 208. Similarly, server devices 206 may communicate with other server devices, kiosks 202, or computing devices 208 through the communications network 206. Likewise, computing devices 208 may communicate with other computing devices or server devices 206 through the communications network 204. The connection to the communications network 204 may be wired or wireless. Thus, the kiosk 202, server devices 206, and the computing devices 208 may include the appropriate components to establish a wired or a wireless connection.

The computer program of the present invention may run on the kiosks 202, on computing devices 208, or alternatively, may run on one or more server devices 206. Additionally, a first portion of the program, code, or instructions may execute on a first server device 206, a first computing device 208, or a first kiosk 202, while a second portion of the program, code, or instructions may execute on a second server device 206, a second computing device 208, or second kiosk 202. In some embodiments, other portions of the program, code, or instructions may execute on other kiosks 202, server devices 206, or computing devices 208 as well. For example, eyeglass information may be stored on a memory element associated with the server device 202, such that the information is remotely accessible to users of the computer program via one or more kiosks 202 or computing devices 208. Alternatively, eyeglass information may be directly stored on the memory element associated with the one or more kiosks 202 or the one or more computing devices 208 of the user. In additional embodiments of the present invention, a portion of the eyeglass information may be stored on the server device 206, while another portion may be stored on the one or more kiosks 202 or the one or more computing devices 208. The various actions and calculations described herein as being performed by or using the computer program may actually be performed by one or more computers, processors, or other computational devices, such as may be included in the kiosk 202, computing devices 208, and/or server devices 206. Such devices may operate independently or cooperatively in executing portions of the computer program.

In certain embodiments of the present invention, the computer program may be executed and/or run on the kiosk computer of the kiosk 202. Further, the computer program may be implemented or run through a computing device 208, via an electronic resource, such as an application, an “app,” or a website. For instance, the computer program may be embodied in a stand-along program downloaded on a user's computing device 208 or in a web-accessible program that is accessible by the user's computing device via the network 204. For the stand-alone program, a downloadable version of the computer program may be stored, at least in part, on the server device 206. A user may download at least a portion of the computer program onto the computing device 208 via the network 204. In such embodiments of the present invention, the computer program may be implemented as an “application,” or as an “app” for a mobile device. After the computer program has been downloaded, the program can be installed on the computing device 208 in an executable format. The executable format of the program permits the user to access embodiments of the present invention via an electronic resource, such as an application, a mobile “app” or website. For the web-accessible computer program, the user may simply access the computer program via the communications network 208 (e.g., the Internet) with the computing device 208.

Certain embodiments may provide for users to create user accounts with which to access embodiments of the present invention, either through the kiosk 202 or through a computing device 208, via the electronic resource. The user accounts may be stored within the memory elements of the kiosk 202, one or more computing devices 208, or the server 206 and/or its associated eyeglass database.

A user account is an account created by or for a user who may implement embodiments of the present invention to acquire eyeglasses with specifically fitted frames and with lenses that correspond to an eyeglass prescription of the user. To establish a user account, each user may be required to enter, or have entered, various types of identification information, such as an email address, name, telephone number, address, date of birth, sex, or the like. Once the user has provided identification information, the user may be required to enter or will otherwise be provided with a username and password, which may be required for the user to login to the user's account and to access the kiosk 202 or the electronic resource via user's computing device 208. In certain embodiments, a user account may be established by the user at the kiosk 202. However, additional embodiment may provide for a user account to be established by the user through the electronic resource via the user's computing device 208. All information entered by the user is generally received, via the network 204, and may be stored on the server device 206 or associated eyeglass database.

Although certain embodiments of the present invention may require a user to establish an account, other embodiments may provide for certain features of the present invention to be utilized, such as browsing or testing the features of the kiosk 202 or the electronic resource, without requiring the establishment of a user account. For instance, a potential user may access the online website and browse and implement certain features of the present invention without needing to register or create an account.

### Operation

Embodiments of the present invention provide for an automated acquisition of eyeglasses with custom fit eyeglass frames and prescription lenses. It is hereby understood that the term eyeglasses may include prescription eyeglasses, non-prescription eyeglasses, prescription sunglasses, and non-prescription sunglasses. However, for clarity, the below description will be provided only with respect to prescription eyeglasses. It is noted, though, that the description may similarly be applied to other forms of eyeglasses. Once a user has established a user account, the process for acquiring eyeglasses can begin by the user providing facial characteristic information via embodiments of the present invention. In certain embodiments, the facial characteristic information may be provided directly to the kiosk 202. The kiosks 202 may be located in various locations and/or facilities, such as, for instance, malls, airports, department stores, pharmacies, health clubs, optometrist/ophthalmologist offices, etc.

The kiosk 202 may obtain an image of the user via the image sensor 304. The kiosk 202 may instruct the user, visually through the graphic display 306 or audibly through speakers integrated with the user interface 308 (or through a visual-audio combination), to stand at a specified distance from the kiosk. In certain embodiments, the image sensor 304 of the kiosk 202 may include a position sensor, such as a radar or LASER sensor, that is capable of sensing the position of the user. In such an embodiment, user's distance from the kiosk 202 can be monitored and instructions can be provided for the user to stand closer to or farther away from the kiosk. In additional embodiments, the kiosk 202 may include a foot placement indicator or a marking, such as an “X”, positioned on a floor space in front of the kiosk that identifies where the user should stand while the imaging sensor 304 obtains an image of the user. By ensuring that the user is positioned at a specified distance from the kiosk 202 and/or the image sensor 304 while the image is obtained, embodiments of the present invention can ensure that the image of the user can be properly analyzed to obtain facial measurements of the user based on the facial characteristic information included in the image.

As previously described, the kiosk 202 may include a single image sensor 304 that is capable of obtaining a single image of the user's head. In certain embodiments, the image sensor 304 may include a wide-angle lens, such that an image can be obtained that includes a front side, portions of a left side, and portions a right side of a user's head. In additional embodiments, the kiosk 202 may include multiple image sensors 304. For instance, the kiosk 202 may include three image sensors. A first image sensor positioned near a longitudinal centerline of the kiosk 202, and second and third image sensors (not shown) positioned on either side of the first image sensor. The first image sensor 304 may be used to obtain image of the front side of the user's head, while the second and third image sensors may be used to obtain images of the left and right sides of the user's head. The images obtained by the first, second, and third image sensors may be combined into a single image, such as a panorama-style image, that is saved on the memory elements of the kiosk 202 or on the server 206. Further, in embodiments where only a single image sensor is used, the image sensor may obtain multiple images of the user's head as necessary to obtain sufficient facial characteristic information.

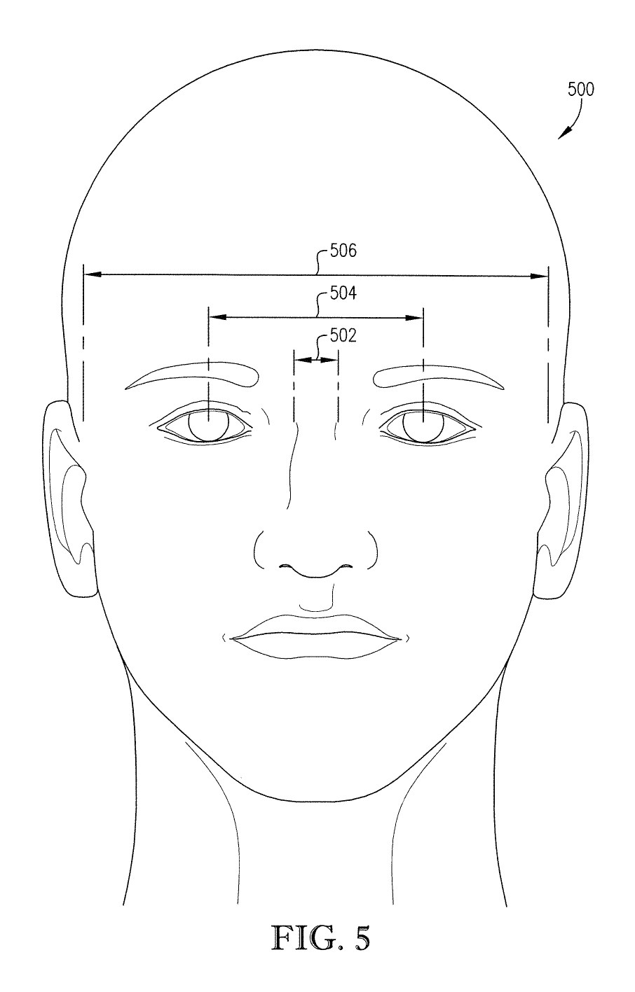

FIG. 5 is illustrative of an image of a user's head 500 obtained by the image device 304 of the kiosk 202. The image may be saved to the memory elements associated with the kiosk 202 or the image may be transmitted to the server 206 via the communications network 204 for storage. Embodiments of the present invention provide for the image of the user to be analyzed to determine facial measurements based on facial characteristics of the user contained in the image. Such facial characteristics may be recognized by implementing image feature recognition algorithms that are capable of extracting landmarks, or features, from the image. For instance, such a feature recognition algorithm may be capable of identifying facial characteristics from the image, such as the user's eyes, nose, cheekbones, brows, forehead, and temples. Because the specific distance of the user from the image sensor 304 of the kiosk 202 is known and further because imaging characteristics of the image sensor are known, embodiments of the present invention provide for a determination of physical measurements between the relative positions of the identified facial characteristics. For instance, embodiments of the present invention may analyze an image of the user's head and obtain measurements based on the number of pixels that exist between various facial characteristics of the user. As an example, an image of a user's head may include 100 pixels between center positions of the user's pupils. If it is known that each pixel represents a distance of 0.03 inches, then embodiments of the present can determine that the user's pupils are 3.0 (i.e., 100×0.03) inches apart. However, the above-stated example is purely exemplary, and the actual correlation between pixels and physical measurements may depend various characteristics, such as the type of camera, the field of view, and the distance of the user to the image sensor 304. In addition, certain embodiments of the present invention may obtain a correlation between pixels and physical measurements by obtaining an image of the user via the image device 304 of the kiosk 202 while the user is wearing the mock eyeglasses 400, as will be described in more detail below.

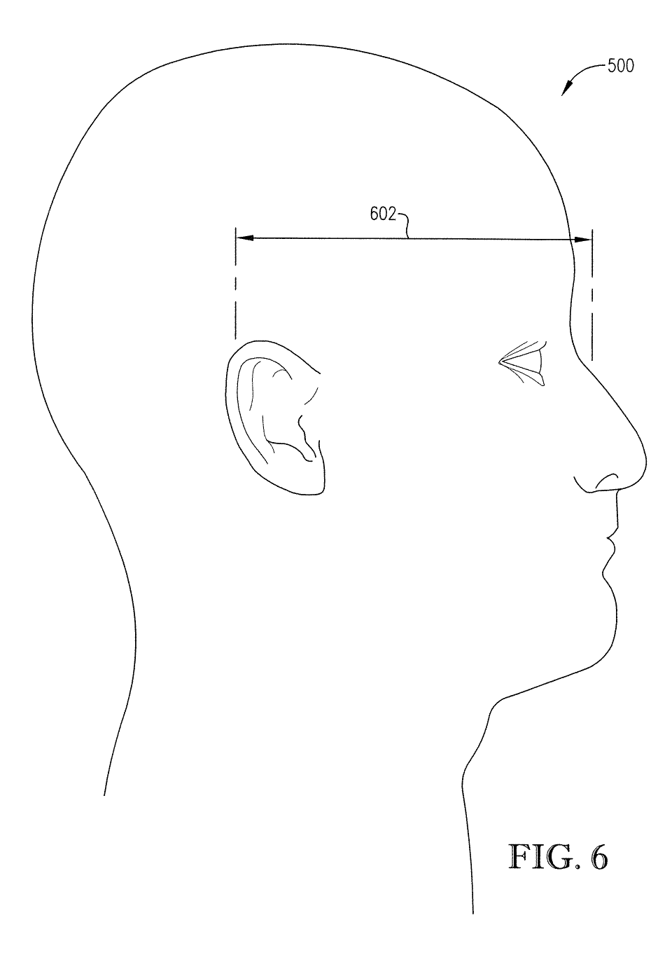

With respect to obtaining custom fit eyeglasses, it is important to determine those certain facial measurements that correlate to components of eyeglass frames. With reference to FIGS. 5-6, such facial measurements may include: a bridge width 502 (i.e., the width of the bridge of the user's nose); a pupil distance 504 (i.e., the distance from the center of the user's left pupil to the user's right pupil); a temple distance 506 (i.e., the distance from the center of the user's left temple to the user's right temple); and a temple stem distance 602 (i.e., the distance from where the glasses will sit on the user's face to the back of the ear).

In addition, embodiments of the present invention may obtain additional information that may be included in the facial measurements, such as relative positions of facial characteristics, size of facial characteristics, face shape, skin tone, eye color, hair color, and other similar information. Such information may be used to suggest or recommend certain styles of eyeglass frames, as will discussed in more detail below. The above-mentioned facial measurements are provided for illustrative purposes and are not meant to be limiting. Thus, additional facial measurements may be obtained as required or necessary for implementing embodiments of the present invention.

Upon obtaining the facial measurement of the user, embodiments of the present invention provide for a presentation of one or more images of eyeglass frames with components that correspond to the determined facial measurements of the user. For instance, a bridge piece of the eyeglass frames included in the one or more presented images of eyeglass frames may correspond to the determined bridge width 502 measured from the image of the user. Similarly, a size of lens rims of the eyeglass frames included in the one or more presented images of eyeglass frames may correspond to the pupil distance 504 and/or the temple distance 506 obtained from the image of the user. Further, a temple stem of the eyeglass frames included in the one or more presented images of eyeglass frames may correspond to the temple stem distance 602 obtained from the image of the user. The presented images of eyeglass frames may include additional components of the eyeglass frames, such as nose pieces, ear pieces, or the like. In additional embodiments of the present invention, the presented eyeglass frame images may not be altered to correspond to the facial measurements of the user. Instead, stock images of eyeglass frames may be presented, with an indication to the user that when such eyeglasses are ordered, the ordered eyeglasses will have components custom fit to the user's facial measurements. Further, it is understood, that although the presented images of eyeglass frames may include components that are or are not altered, when a user orders an eyeglass frame, such components of the ordered eyeglass frame will be custom fit to correspond to the user's facial measurements.

The eyeglass frames included in the one or more presented images of eyeglass frames may be matched and selected from a depository of eyeglass frame images stored in the eyeglass database of the server 206. The eyeglass database may include information indicative of a plurality of eyeglass frames that are available to be ordered through embodiments of the present invention, as will be discussed in more detail below. In further embodiments, the presented eyeglass frame images may be obtained from a third-party eyeglass databases operated by third-party eyeglass frame providers. For instance, embodiments of the present invention may provide for an electronic connection with a third-party eyeglass frame database to obtain images of eyeglass frames available for ordering and/or purchase through the third-party eyeglasses provider. Embodiments of the present invention may provide all or a subset of all the eyeglass frame images stored in the eyeglass database to be altered such that the measurements of the components of the eyeglass frames in the presented images correspond to the facial measurements determined from the image of the user.

The presented images of eyeglass frames may be presented to the user via the graphic display 306 of the kiosk 202. The presented images of eyeglass frames may be presented in various forms, such as in a single image, a list, or an array form. In the list or array form, the presented images may be presented in small, thumbnail type images. In addition, the graphic display 306 may allow the user to scroll through the presented thumbnail images, so as to allow the user to browse through all of the presented images of eyeglass frames. In further embodiments, the user may select or highlight a particular image of an eyeglass frame, such that the graphic display 306 of the kiosk 202 will present a larger, full-sized image of the selected image of the eyeglass frame.

In additional embodiments of the present invention, the presented images of eyeglass frames may include lenses in each of the lens rims of the eyeglass frames, such that the user can visualize what the eyeglass frames will look like with lenses inserted into the eyeglass frames. The lenses may come in various styles, tints, coatings, thicknesses, and prescriptions, such that the user can select an appropriate lens style to emulate. In even further embodiments of the present invention, the user may select to have a selected image of an eyeglass frame to be overlaid onto the image of the user and displayed via the graphic display 306 of the kiosk 202. Thus, the user can observe what a selected eyeglass frame (and lenses) will look like while the user is wearing them.

The above-mentioned presentation of images of eyeglass frames was determined based on the presented eyeglass frame components (i.e., bridge piece, lens rims, temple stems) having measurements that corresponded to the facial measurements obtained from the image of the user. Embodiments of the present invention further provide for a consultation component that provides users with a recommendation of eyeglass frames that correspond with the user's interests, preferences, facial measurements, and current styles and trends. The consultation component may be implemented through a virtual-consultant, which may be a graphic representation of a virtual fashion consultant displayed on the graphic display 306 of the kiosk 202. The virtual-consultant may be displayed in a humanoid-type form and may interact in real-time with the user, such as to obtain interest and preference information from the user. In other embodiments, the consultation component may simply interact with the user through a series of textual prompts and questions. In response to the obtained interest and preference information, the facial measurements, and current styles and trends, the consultation component is operable to present a list of images of eyeglass frames that conform to the user's interests, preferences, facial measurements, and current styles and trends.

The consultant component may begin a consultation by asking the user a series of questions relating to the user's interests and preferences. For example, the consultant may ask whether the user will wear the eyeglasses for exercises, for outdoor work, for office work, for leisure, etc. In addition, the consultation component may ask for certain user preferences, such as likes and dislikes, preferred colors, styles, brands, weights, price ranges, or the like. The questions posed by the consultant component may be asked by the virtual consultant graphically on the graphic display 306 and/or audibly through the speakers of the kiosk 202. In additional embodiments, the questions may be posed in a more basic textual format that is displayed on the graphic display 306 of the kiosk 202. The user can interact with the consultation component and answer the question from the virtual consultant by speaking directly into a microphone associated with the kiosk 202. Embodiments of the present invention may provide for speech-to-text algorithms capable of interpreting the spoken answers input by the user. In additional embodiments, the user may answer the questions by manually manipulating the user interface 308 and/or the GUI of the kiosk 202. The answers provided by the user are referred to herein as interest and preference information and can be used by the consultant component to recommend eyeglass frames that correspond to the user's interests and preferences.

After obtaining the interest and preference information, embodiments of the present invention provide for further analysis of the facial measurements obtained from the image of the user. Such further analysis may include a determination of skin tone, eye color, hair color, or other aesthetic-type information that can obtained from the image of the user. Based on the interest and preference answers provided by the user, the user's facial measurements, and the current styles and trends, the consultation component can present a list of images of eyeglass frames that are recommend for the user. For example, a first user may interact with the kiosk 202 to obtain a first eyeglass frame. The first user's answers to the interest and preference questions may indicate that the user is an exercise enthusiast who is planning on wearing the first eyeglass frame while bike riding. In addition, embodiments of the present invention may analyze the first user's image to determine that the first user has a “fair” complexion. Based on the results of the consultation component and the analysis of the facial measurements, the consultation component may recommend to the first user several eyeglass frames that are light-weight and light-colored. The consultation component may determine that the light-weight eyeglass frame will be more comfortable for the first user to wear while bike riding. In addition, the consultant component may further recommend that light-colored glasses are a better suited style for a user with a “fair” complexion. As an additional example, a second user may interact with the kiosk 202 to obtain a second eyeglass frame. The second user's answers to the interest and preference question may indicate that the user is businessman that plans on wearing the second eyeglass frame during work, in an office setting. In addition, analysis of the facial measurements of the second user's image may indicate that the second user has a square-shaped face. Based on the analysis of the interest and preference information, facial measurements, and current styles and trends, the consultation component may recommend to the second user several eyeglass frames that have thick frame components (i.e. thick lens rims, thick temple stems, etc.) and that are dark colored. The consultant component may determine that eyeglass frames with thick components may be a better suited style for a user with a square-shaped face. In addition, the consultant component may suggest that dark colored glasses are a preferred style for wear during work in an office setting. However, such above-mentioned suggestions by the consultation component are purely illustrative, and embodiments of the present invention may include a plurality of suggestions based on a total analysis of the user's interests, preferences, facial measurements, and current trends and styles.

As should be understood, the presented images of eyeglass frames may include images of eyeglass frames with components that correspond both with the facial measurements obtained from the image of the use, as well as the user's interests, preferences, facial measurements, and current trends and styles obtained from the consultation component. It should also be understood, that the presented images of eyeglass frames may be based either solely on the facial measurements or on the consultation component. For instance, if a user does not wish to participate in the consultation component, the user can simply choose to have eyeglass frames presented that match the facial measurements obtained from the user's image. Alternatively, a user can simply participate in the consultation component without submitting an image, such that embodiments of the present invention can suggest eyeglass frames that match the user's interests, preferences, and current trends and styles.

After a user has selected one or more eyeglass frames from the images of presented eyeglass frames, embodiments of the present invention further provide for eyeglass prescriptions to be obtained from prescription providers, such as the user's eye doctor, optometrist, ophthalmologist, or the like. To obtain the eyeglass prescription, the user must initially authorize for the user's prescription provider to release the eyeglass prescription. The authorization may come in the form of a medical release that is executed by the user via the kiosk 202. Embodiments of the present invention may provide for the medical release to be displayed on the graphic display 306 of the kiosk 202. After reading the information contained in the medical release, the user can authorize the release of their eyeglass prescription by electronically signing (i.e., executing) the medical release. In certain embodiments, the user may be required to enter a contact information of their prescription provider, including the provider's name, address, phone number, Fax number, etc. In additional embodiments, the memory elements of the kiosk computer and/or the server 206 may store a plurality of prescription provider contact information, such that the user can search for their prescription provider from the plurality of stored prescription providers. Thus, if the user's prescription provider is found to have been stored in the kiosk computer and/or server 206, then the prescription provider contact information can be automatically added to and associated with the medical release. The electronic signature may be provided by the user by selecting or “clicking” on an appropriate button on the user interface 308, by signing the medical release via the GUI of the graphic display 306, or any other available means of acknowledging authorization through the kiosk 202.

Once the medical release has been executed by the user, the medical release may be provided to the prescription provider to authorize the release of the user's eyeglass prescription. The medical release may be provided to the prescription provider by sending the medical release over the communications network 204 from the kiosk 202 or the server 206. For instance, the medical release may be sent via Fax, Electronic Fax, email, file transfer protocol (FTP), secure FTP (SFTP), or the like, to the phone number, Fax number, or other electronic address associated with the prescription provider. After sending the medical release to the prescription provider, embodiments of the present invention may similarly receive the user's eyeglass prescription from the prescription provider via Fax, Electronic Fax, Email, FTP, SFTP, or the like. As previously mentioned, embodiments of the present invention may store contact information for a plurality of prescription providers in the kiosk computer and/or the server 202 or the associated eyeglass database. In addition, embodiments may provide for the plurality of prescription providers to store eyeglass prescriptions in the server 202 or the associated eyeglass database. In such embodiments, the eyeglass prescriptions may be directly obtained (after obtaining an executed medical release) by searching through those eyeglass prescriptions stored in the server 202 and/or associated eyeglass database. Thus, for those users whose prescription providers store prescriptions in the server 202, embodiments of the present invention provide for a quick and efficient means for obtaining the eyeglass prescriptions once a medical release has been executed by a user.

Upon obtaining a selection of one or more eyeglass frames from a user and further upon obtaining the user's eyeglass prescription from the user's prescription provider, embodiments of the present invention provide for an automated ordering of eyeglasses that includes the selected frames and lenses with the user's prescription. It should be noted, that embodiments of the present invention provide for acquiring non-prescription eyeglass, such as sunglasses or other non-prescription eyeglasses. Thus, embodiments of the present invention provide for users to order eyeglasses without requiring a prescription to be obtained. The eyeglasses may be ordered from an eyeglass provider, such as a third-party manufacturer of eyeglass frames, a third-party manufacturer of lenses, an ophthalmologist or optometrist office, or a combination of the above. The order may be provided via the communications network to the third-party manufacturers, such as through Fax, Electronic Fax, email, Internet, FTP, SFTP, or the like. The order includes the type of frame that was selected by the user, as well as the facial measurements of the user, such that the third-party manufacturer can manufacturer the eyeglass frame components (e.g., bridge piece, lens rims, temple stems, etc.) according to the user's facial measurements. The order will additionally include the user's obtained eyeglass prescription, such that the eyeglass frames can be fitted with lenses that correspond to the user's eyeglass prescription. Once the eyeglasses have been manufactured, the eyeglasses are automatically delivered to the address associated with the user's account.

In additional embodiments, certain eyeglass frames and lens prescriptions may be so common (e.g., reading glasses) that pre-manufactured eyeglasses fitting the user's facial measurements and eyeglass prescriptions are readily available. Such pre-manufactured eyeglasses may also include non-prescription eyeglasses, such as sunglasses. In such embodiments, the pre-manufactured eyeglasses may be ordered, via the kiosk 202, directly from a retail store, eyeglass supplier, or warehouse, and delivered to the address associated with the user without requiring the order to first be sent to a third-party manufacturer. In even further embodiments, such pre-manufactured eyeglasses may be stored in the kiosk 202, such that upon ordering the pre-manufactured eyeglasses from the kiosk, the kiosk may automatically dispense the pre-manufactured eyeglasses to the user. In such embodiments, the pre-manufactured eyeglasses may be dispensed from the dispenser 310 of the kiosk 202 or from another dispenser included in the kiosk. In still further embodiments, the pre-manufactured eyeglasses may not be stored within the kiosk 202, but may instead be available at the location where the kiosk is situated or at another retail store, eyeglass supplier, or the like. In such embodiments, upon the user placing an order at the kiosk 202, the kiosk may be configured to dispense a coupon, receipt, or other indication of purchase, such that the user can remit the indication of purchase to obtain the pre-manufacture eyeglasses. Thus, the kiosk 202 may include the components necessary for dispensing coupons, receipts, or the like (e.g., a receipt printer). For example, if the kiosk 202 is located at an optometrist office, the optometrist office may have an inventory of pre-manufactured eyeglasses available for purchase. In such embodiments, upon the user placing an order at the kiosk 202, the kiosk may be configured to dispense a coupon, receipt, or other indication of purchase that may be redeemed by the optometrist office in exchange for the pre-manufacture eyeglasses.

As noted, the user can purchase the ordered eyeglasses directly from the kiosk 202. The user may make the purchase by entering payment information directly into the user interface 308 and/or the GUI of the kiosk 202. The payment information may be, for instance, credit card number, gift card number, coupon, or the like. In additional embodiments, the kiosk 202 may include a point-of-sale device, with a magnetic swipe reader or a near filed communications (NFC) reader, which permits users to swipe a credit card (or other payment device) directly at the kiosk. Once the payment information is obtained, such may be transmitted over the communications network 204 to the server 206 for payment processing.

The above-provided description for automated acquisition of eyeglasses was directed to acquisition from the kiosk 202. In addition, embodiments of the present invention provide for users to order eyeglasses from the comfort of their home, or any other location where the user has access to a computing device 208. All of the information that was obtained at the kiosk 202 (e.g., the user's image, facial measurements, interest and preference information, etc.) is saved and stored in the sever 202 or the associated eyeglass database. In addition, because such information is associated with the user' user account, the user can access embodiments of the present invention from a computing device 208 by logging-in to the user's user account with the user's username and password and accessing the electronic resource. Thus, after a user has provided an image to the kiosk 202, the image, the facial characteristics, and the facial measurements are stored in the server 202, such the user can access the information and/or use the information to order glasses from their computing device 208.

The steps for selecting and ordering eyeglasses from the user's computing device 208 are similar to that described above for the kiosk 202. For instance, a user that initially created a user account and uploaded an image at the kiosk 202 can thereafter return home, select, and order eyeglasses from a computing device 208. Once the user has returned home, the user can access embodiments of the present invention via the electronic resource (i.e., an application, an “app”, or a website). The user must initially log-in to the electronic resource, via the computing device 208, with the username and password associated with the user account. Once logged-in, the user can select and order eyeglasses similar to the description provided above. Embodiment of the present invention are operable present one or more images of eyeglass frames, via the electronic display of user's computing device 208, with eyeglass frame components that match the facial measurements determined from the image of the user obtained at the kiosk 202. In additional embodiments, the user may interact, via the computing device 208, with the consultation component to obtain additional suggested eyeglass frames based on the user's interest and preference information, facial measurements, and present styles and trends, as was previously described. The user may additional execute a medical release to provide authorization for the user's prescription provider to release the user's eyeglass prescription, as was previously described. Once the user has selected one or more eyeglass frames to order and has executed the medical release, embodiments of the present invention provide for the automatic ordering of the custom fit eyeglasses selected by the user, as was previously described.

In addition to selecting and ordering eyeglasses from the user's computing device 208, embodiments of the present invention provide for an image of a user to be obtained from the user's computing device. In such embodiments, the user may use the camera on the user's computing device 208 to obtain the image. Because of distinctions between different types of cameras that may be used on computing devices and further because physical measurements of imaged objects are difficult to determine when the objects are positioned at unknown distances and angles from such cameras, embodiments of the present invention provide for users to wear the mock eyeglasses 400 when an image of the user is obtained from the camera of the user's computing device 208. In particular, the measuring device 404 on the mock eyeglasses 400 acts as a frame of reference for the image, allowing embodiments of the present invention to precisely correlate physical measurements on the measuring device with physical measurements of facial characteristics of the user, so as to accurately determine facial measurements. As previously described, the mock eyeglasses 400 may be obtained from the mock eyeglasses dispenser 210 of the kiosk 202. In certain embodiments, the user may obtain the mock eyeglasses 400 while enrolling in a user account at the kiosk 202. In additional embodiments, the user may not enroll in a user account at the kiosk 202, and may simply obtain the mock eyeglasses 400 from the kiosk and later enroll in a user account from the user's computing device 208.

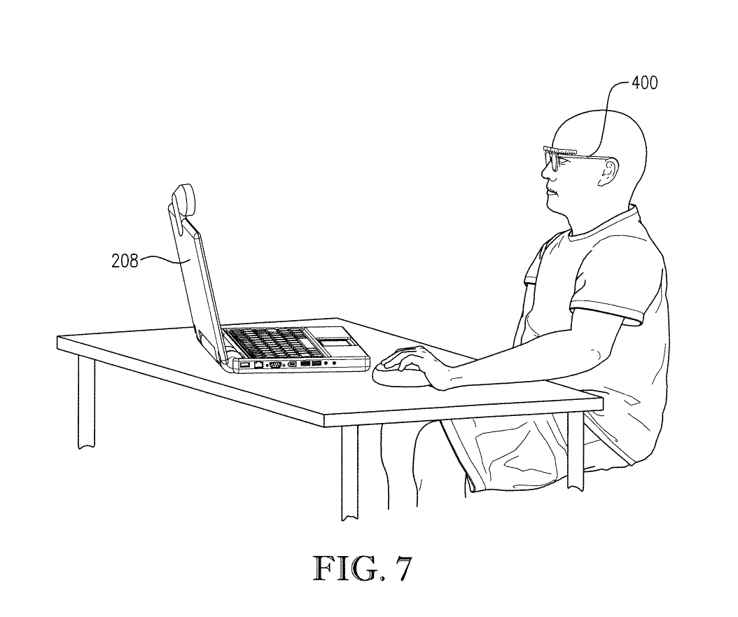

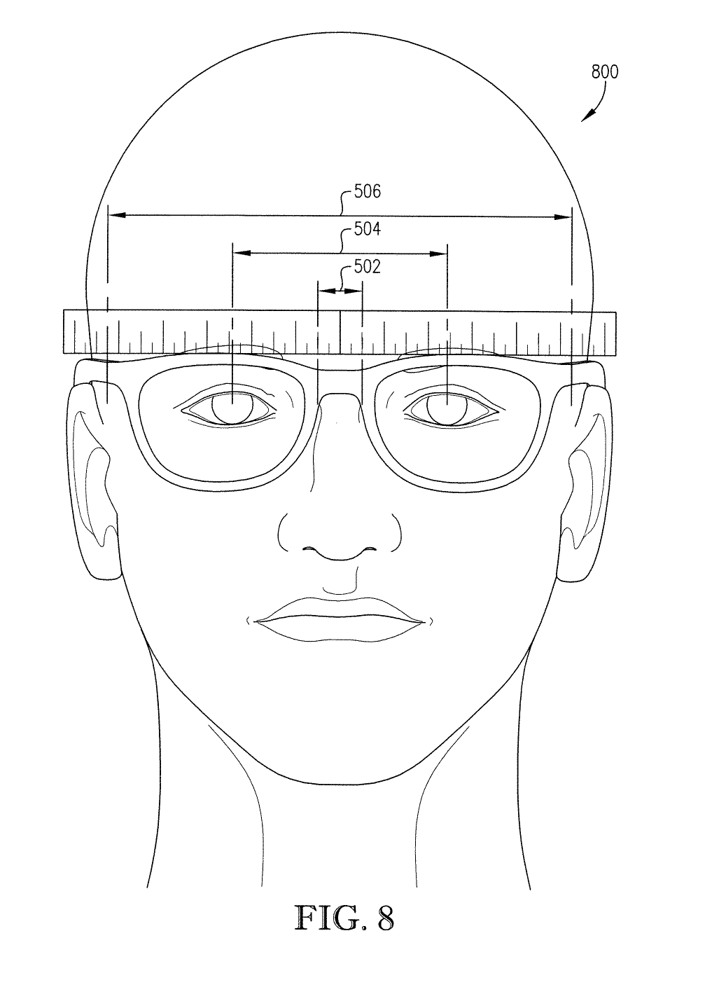

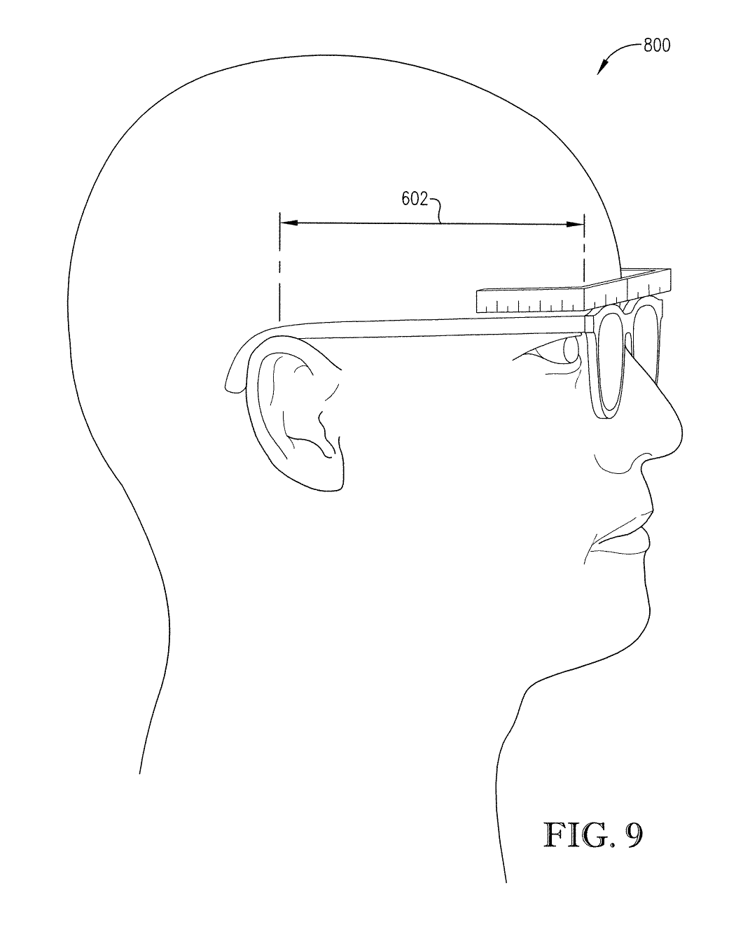

Once the user has obtained the mock eyeglasses 400, the user can log-in to the user's user account, via the electronic resource, from the user's computing device 208. As illustrated by FIG. 7, the user can then upload an image of the user's head while wearing the mock eyeglasses 400. FIG. 8 is illustrative of an image of a user's head 800 obtained by the camera of the user's computing device 208. The image may be saved to the memory elements associated with the computing device 208 or the image may be transmitted to the server 206 via the communications network 204 for storage. In certain embodiments, the user may upload multiple images. For example, the user may upload an image of the front of the user's head, as illustrated in FIG. 8. In addition, the user may upload an image of either or both sides of the user's head, such as illustrated in FIG. 9.

Once captured by the camera, embodiments of the present invention may thereafter analyze the image of the user to obtain the facial measurements from the facial characteristics as was previously described. For instance, with reference to FIGS. 8-9, such facial measurements may include: the bridge width 502; the pupil distance 504; the temple distance 506; and the temple stem distance 602. However, because the distance of the user from the camera is generally unknown and further because the imaging characteristics of the camera are unknown, embodiments of the present invention provide for a determination of measurements between the relative positions of the facial characteristics by requiring that the user wear the mock eyeglasses 400 with the measuring device 404. As previously described the measuring device 404 provides for embodiments of the present invention to determine physical measurements of objects positioned at unknown distances from the camera. For instance, in the example given previously, each pixel in an image represented a distance of 0.03 inches on an object in the image. However, in a second example, consider a user wearing the mock eyeglasses 400 that uploads an image of the user's head, such as illustrated in FIG. 8. Embodiments of the present invention can analyze markings on the measuring device 404 to determine that each pixel in the image represents a distance of 0.05 inches. Thus, the image of the user, whose pupils are physically separated by 3.0 inches, would have approximately 60 pixels separating the user's pupils in the image. As can be seen then, by wearing the mock eyeglasses 400 while the image of the user is obtained, embodiments of the present invention can determine accurate facial measurements by correlating known distances on the measuring device 404 with a number of pixels separating the known distances. Therefore, images obtained from a wide range of cameras on computing devices 208 may be used in embodiments of the present invention.

Once the image of the user is obtained from the computing device 208 and embodiments of the present invention determine facial measurements from the image, the remaining steps for selecting, ordering, and purchasing eyeglasses are the same as previously described. The user may be presented with one or more images of eyeglass frames with components that match the facial measurements obtained from the image. The user may also choose to be presented with a graphic representation of a selected eyeglass frame overlaid on the image of the user, such that the user can see what the user would look like while wearing the eyeglass frames. Embodiments of the present invention may also suggest certain eyeglass frames as provided by the consultation component, as previously described. The steps for obtaining eyeglass prescriptions, ordering, and purchasing the eyeglasses are also similar to what was previously described. Thus, embodiments of the present invention provide for the automated acquisition of eyeglass from a computing device 208 of the user, such that the user is not required to perform the above-described steps at a kiosk 202.

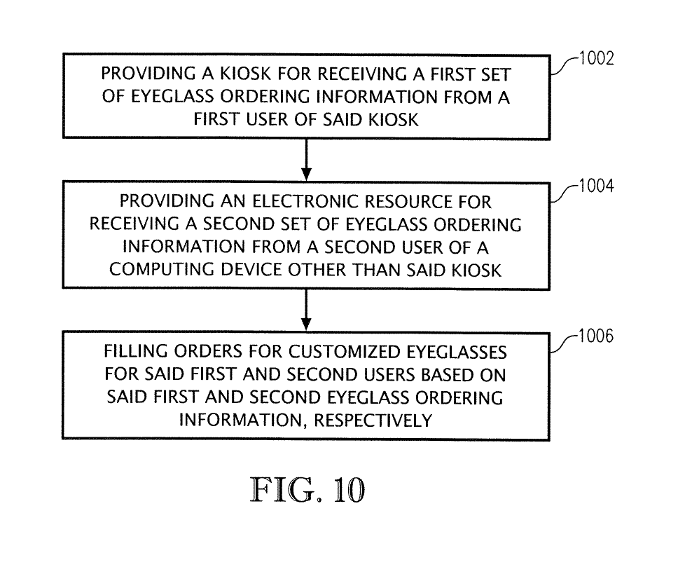

Thus, as illustrated in FIG. 10, embodiments of the present invention may include a computer program, a system, and a method that includes an initial Step 1002 of providing a kiosk for receiving a first set of eyeglass ordering information from a first user of said kiosk. In the next Step 1004, the method includes providing an electronic resource for receiving a second set of eyeglass ordering information from a second user of a computing device other than the kiosk. Finally, in Step 1006, the method includes filling orders for customized eyeglasses for said first and second users based on said first and second eyeglass ordering information, respectively.

Once a user's user account has been associated with information pertaining to the use of embodiments of the present invention (e.g., the user's image, facial measurements, interest and preference information, etc.), the user may use such information to order additional eyeglasses in the future without having to re-enter the information. For instance, after a user has acquired a pair of eyeglasses via embodiments of the present invention, the user's preference and interest information, and other related information are associated with the user's account and stored in the server or the associated eyeglasses database. Thereafter, if the user would like to make an additional acquisition of eyeglasses, the user can log-on to the user's user account, either at a kiosk 202 or at a computing device 208, and order additional eyeglasses with components that match the user's facial measurements and with lenses that correspond to the user's eyeglass prescription. Thus, the user does not have to repeat each of the steps to make subsequent orders for eyeglasses.

### Additional Features

In addition to the automated acquisition of eyeglasses, embodiments of the present invention are operable to provide additional functionality, such as health screening services and fashion consulting services for articles other than eyeglasses. Beginning with the health screening services, the kiosk of embodiments of the present invention may provide for a user to obtain plurality of health screening tests. For instance, the user may obtain a health screening tests on vision, blood pressure, and body mass index (BMI). The vision screening measurements may include basic tests for visual acuity or color blindness. The vision screening measurements may be performed by displaying a vision test on the graphic display 306 of the kiosk 202. For instance, the graphic display 306 may present eye charts, such as a logMar chart, a Snellen chart, a Londolt C, a Lea test, or the like. A user may be required to stand at a specific distance from the kiosk 202 and attempt to identify symbols on the presented chart. Depending on the ability of the user to identify the symbols on the chart, embodiments of the present invention may indicate to the users that the results of the vision test were abnormal and may recommend that the user visit an eye care professional for further diagnosis. For instance, if a Snellen chart were displayed on the graphic display 306, and the user was only able to identify the symbols on the top three rows, then the kiosk 202 may indicate to the user that the user may have a refractive error or an ocular disorder and should thus visit a health care professional for further diagnosis. Similarly, embodiments of the present invention may display a color blindness test, such as an Ishihira color test, on the graphic display 306 of the kiosk 202. Depending on the outcome of the test, embodiments of the present invention may indicate that a user should consult with an eye care professional. Embodiments of the present invention may also recommend eye care professionals to user's based on eye care professional information such as type of practice, type of specialty, office locations, insurance coverage, etc.

In addition to vision tests, embodiments of the present invention may provide for BMI calculations to be performed. BMI is a measure of a user's body shape based on the ratio of the user's mass to a square of the user's height. In certain embodiments, the user may manually enter the user's weight and height via the GUI or user interface 308 of the kiosk 202. In additional embodiments, the kiosk 202 may include a scale, such that the user can step onto the scale to determine an accurate weight. The scale may be operate separately from the kiosk 202, or it may be integrated with the kiosk, such that after a user steps on the scale, the user's weight is automatically transmitted to the kiosk computing device for use in a BMI calculation. Similarly, the kiosk may include a height measurement apparatus, such as a stadiometer, so that the user can accurately determine the user's height. In further embodiments, the height measurement apparatus may be integrated with the kiosk 202, such that after the user measures a height, the user's height is automatically transmitted to the kiosk computing device for use in the BMI calculation. A user's BMI can be compared to average BMIs based on BMI charts. Depending on the comparison of a user's BMI with a BMI chart, embodiments of the present invention may indicate to the user that the user may be underweight, normal, or overweight. If the user's BMI deviates from the normal, embodiments may indicate that the user should visit a health care professional, dietician, or the like. Embodiments of the present invention may also recommend health care professionals to the user based on health care professional information such as type of practice, type of specialty, office locations, insurance coverage, etc.

Embodiments of the present invention may also provide for blood pressure and heart rate checks. The kiosk may include the necessary components for obtaining a user's blood pressure and heart rate measurement, such as a blood pressure meter with a cuff and manual/digital pressure sensors. The blood pressure meter may be connected to the kiosk 202 and may display the results of a user's blood pressure and heart rate on the graphic display 306. The results may display the measure blood pressure and heart rate and may also indicate whether such measurements are below-normal, normal, or above-normal. Depending on the measured blood pressure and heart rate of the user, embodiments of the present invention may indicate that the user should visit a health care professional to seek further diagnosis regarding the measured blood pressure and/or heart rate. Embodiments of the present invention may also recommend health care professionals to the user based on health care professional information such as type of practice, type of specialty, office locations, insurance coverage, etc.

In addition to health screening services, embodiments of the present invention may provide fashion consulting services, which offer recommendations for a user to order and/or purchase articles other than eyeglasses from the kiosk 202. Such other articles may include for instance shirts, pants, dresses, jewelry, hats, footwear, or the like. In certain embodiments, the user may enter the user's size measurements, and suggested articles may be presented, via the graphic display 306, similar to how the images of eyeglass frames were presented. In addition, the consultant component may ask certain questions to determine the user's preferences and interests. Based on the user's size measurements, preferences, interests, and current styles and trends, the consultation component may suggest particular articles for the user to order and purchase. Upon selecting one or more articles, the user may order and purchase the selected articles similar to how the eyeglasses were ordered above.

In particular, with respect to footwear articles, embodiments of the present invention may include a foot measurement device that functions to obtain the size measurement of a user's foot. In certain embodiments, the user may simply enter the user's foot size manually. However, other embodiments provide for an automated acquisition of the user's foot size via the foot measurement device. The foot measurement device may include a Brannock device, which allows for width and length measurements of the users feet to be obtained through mechanical measurement means. The foot measurement device may be integrated with the kiosk, such that once a measurement has been obtained, the information regarding the measurement is transmitted to the kiosk computing device for use in recommending footwear. In additional embodiments, the foot measurement device may include electronic foot sensors that function to sense the size and pressures of the user's feet. For instance, such electronic foot sensors may include temperature sensors, pressure sensors, or the like. Similarly, such measurement information may be sent to the kiosk computing device for use in recommending footwear that corresponds to the measured size and/or pressures of the user's foot. Once a user has selected one or more articles of footwear, the user can order and purchase the footwear similar to how the eyeglasses were ordered and purchased above.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for automated acquisition of eyeglasses, comprising:
a kiosk including—
an image sensor; and
a computer having:
a non-transitory computer-readable storage medium with an executable program stored thereon, wherein the program instructs the processor to perform the following steps:
obtain an image of a user, via the image sensor, wherein the image includes facial characteristic information of the user,
calculate facial measurements of the user based on the facial characteristic information included in the image of the user,
present one or more images of eyeglass frames to the user, wherein the eyeglass frames in the presented images correspond to the calculated facial measurements of the user,
obtain a selection from the user of an eyeglass frame to order, wherein an image of the eyeglass frame to order was included in the one or more presented images of eyeglass frames,
connect to a prescription provider,
collect an eyeglass prescription of the user from the prescription provider,
connect to an eyeglass provider, and
order eyeglasses from the eyeglass provider, wherein the ordered eyeglasses include the eyeglass frame to order and further include lenses that correspond to the eyeglass prescription obtained from the prescription provider.

2. The system of claim 1, wherein the facial characteristics information includes information regarding one or more of the user's eyes, nose, cheekbones, brow, forehead, and temples.

3. The system of claim 1, wherein the facial measurements include one or more of the following—
a bridge width;
a pupil distance;
a temple distance; and
a temple stem distance.

4. The system of claim 3, wherein the eyeglass frames included the one or more presented images have eyeglass frame components that include a bridge piece, a lens rim, and a temple stem.

5. The system of claim 4, wherein the eyeglass frames in the presented images correspond to the calculated facial measurements of the user based on the bridge piece corresponding to the bridge width of the user, the lens rim corresponding to the pupil distance and temple distance of the user, and the temple stem corresponding to the temple stem distance of the user.

6. The system of claim 1, wherein the program further instructs the processor to perform the following steps:
obtain an executed medical release from the user; and
send the executed medical release to the prescription provider.

7. The system of claim 6, wherein the executed medical release is sent to the prescription provider by one or more of: fax, electronic fax, email, and file transfer protocol.

8. The system of claim 1, wherein the eyeglass frames in the presented images further correspond to one or more of: a preference of the user, an interest of the user, and current trends and styles.

9. A method for automated acquisition of eyeglasses, with the method comprising the following steps:
obtaining an image of a user, wherein the image includes facial characteristic information of the user;
calculating facial measurements of the user based on the facial characteristic information included in the image of the user;
presenting one or more images of eyeglass frames to the user;
obtaining a selection from the user of an eyeglass frame to order, wherein an image of the eyeglass frame to order was included in the one or more presented images of eyeglass frames;
connecting to a prescription provider;
collecting an eyeglass prescription of the user from the prescription provider;
connecting to an eyeglass provider; and
ordering eyeglasses from the eyeglass provider, wherein the ordered eyeglasses include the eyeglass frame to order, with the eyeglass frame to order corresponding to the calculated facial measurements of the user, and further wherein the ordered eyeglasses include lenses that correspond to the eyeglass prescription obtained from the prescription provider.

10. The method of claim 9, wherein the facial characteristics information includes information regarding one or more of the user's eyes, nose, cheekbones, brow, forehead, and temples.

11. The method of claim 9, wherein the facial measurements include one or more of the following—
a bridge width;
a pupil distance;
a temple distance; and
a temple stem distance.

12. The method of claim 11, wherein the eyeglass frames included the one or more presented images eyeglass frames have eyeglass frame components that include a bridge piece, a lens rim, and a temple stem.

13. The method of claim 12, wherein the eyeglass frame to order corresponds to the calculated facial measurements of the user based on the bridge piece corresponding to the bridge width of the user, the lens rim corresponding to the pupil distance and temple distance of the user, and the temple stem corresponding to the temple stem distance of the user.

14. The method of claim 9, further including the following steps:
obtaining an executed medical release from the user; and
sending the executed medical release to the prescription provider.

15. The method of claim 14, wherein the executed medical release is sent to the prescription provider by one or more of: fax, electronic fax, email, and file transfer protocol.

16. The method of claim 9, wherein the eyeglass frames in the presented images further correspond to one or more of: a preference of the user, a skin tone of the user, and current trends and styles.

17. The method of claim 9, wherein the method for automated acquisition of eyeglasses is executed via an electronic device.

18. The method of claim 17, wherein the electronic device is a kiosk or a computing device other than the kiosk.

19. A method for automated acquisition of eyeglasses, comprising:
providing a kiosk for receiving a first set of eyeglass ordering information from a first user of said kiosk;
providing an electronic resource for receiving a second set of eyeglass ordering information from a second user of a computing device other than said kiosk;
filling orders for customized eyeglasses for said first and second users based on said first and second eyeglass ordering information, respectively.

20. The method of claim 19, wherein said first eyeglass ordering information received from said first user includes an image of said first user's head obtained via said kiosk.

21. The method of claim 19, wherein said kiosk is operable to dispense mock eyeglasses, with said mock eyeglasses including a measurement device.

22. The method of claim 21, wherein said second eyeglass ordering information received from said second user includes an image of said second user's head obtained via said computing device, with said image including said second user wearing said mock eyeglasses on said second user's head.

23. The method of claim 19, wherein said electronic resource also receives said first eyeglass ordering information from said kiosk.
